(19) United States
(12) Patent Application Publication
(10) Pub. No.: US 2014/0124233 A1
(43) Pub. Date: May 8, 2014

(54) Antigalloping Device

(71) Applicant: Albert S. Richardson, JR., Lexington, MA (US)

(72) Inventor: Albert S. Richardson, JR., Lexington, MA (US)

(21) Appl. No.: 13/739,752

(22) Filed: Jan. 11, 2013

Related U.S. Application Data
(60) Provisional application No. 61/724,161, filed on Nov. 8, 2012.

(51) Int. Cl. H02G 7/14; H02G 1/04

(52) U.S. Cl. CPC H02G 7/14; H02G 1/04
USPC 174/42; 29/452

(57) ABSTRACT

An antigalloping device can include first and second clamps, each having a respective jaw for clamping to respective first and second cables. A connecting assembly can be coupled between the first and second clamps. The connecting assembly can include an elongate insulator attached to a length of flexible cable. The length of flexible cable is capable of being bent and maneuvered during installation. At least one of the first and second clamps can be rotatably coupled to the connecting assembly. The elongate insulator and the flexible cable can straighten along a longitudinal axis. The at least one of the first and second clamps can be orientatable in a position transverse to the longitudinal axis for being rotatable between the position transverse to the longitudinal axis and a position inline with the longitudinal axis, under opposed tension exerted on the jaws of the first and second clamps, for twisting at least one of the first and second cables for reducing galloping.

### RELATED APPLICATION(S)

This application claims the benefit of U.S. Provisional Application No. 61/724,161, filed on Nov. 8, 2012. The entire teachings of the above application(s) are incorporated herein by reference.

### BACKGROUND

A span of electrical transmission conductors between transmission towers can be large, often for example between 700 to 1200 feet, and during winter storms, ice accumulating on the electrical conductors can form aerodynamic lifting or wing shaped structures. As the wind passes over the ice wing shaped structures, the conductors can lift, causing galloping of the conductors up and down, which if not controlled, can cause damage to the conductors and the towers. One prior method of addressing such galloping is to connect an interphase spacer between the phase conductors, which can be individual conductors or can include bundles of conductors. In cases where the interphase spacer is connected between two bundles of conductors, bundle spacer rings or devices are secured to each bundle of conductors, for spacing the conductors in the bundle from each other, and the interphase spacer is connected to and between the bundle rings of the two bundles. Often, the interphase spacer includes two or more rigid elongate insulator rods, which can be connected together with joints. The distance between the conductor phases can often be about 24 to 33 feet apart, so that the insulator rod assembly must have the same length. This can make the interphase spacer expensive, as well as long, heavy and unwieldy to install, for example from a helicopter on high transmission lines.

### SUMMARY

The present invention can provide an antigalloping device for securement to lines, cables or conductors, such as phase conductors, that are separated by long distances, where the device is less costly and easier to install than devices in the prior art. The antigalloping device can include first and second clamps, each having a respective jaw for clamping to respective first and second cables. A connecting assembly can be coupled between the first and second clamps. The connecting assembly can include an elongate insulator attached to a length of flexible cable. The length of flexible cable is capable of being bent and maneuvered during installation. At least one of the first and second clamps can be rotatably coupled to the connecting assembly. The elongate insulator and the flexible cable are capable of being straightened along a longitudinal axis. The at least one of the first and second clamps can be orientatable in a position transverse to the longitudinal axis for being rotatable between the position transverse to the longitudinal axis and a position inline with the longitudinal axis, under opposed tension exerted on the jaws of the first and second clamps, for twisting at least one of the first and second cables for reducing galloping.

In particular embodiments, the length of flexible cable is flexibly collapsible under opposed compression. The first and second clamps can be rotatably coupled to opposite ends of the connecting assembly about respective clamp joint axes. The elongate insulator and the flexible cable can be rotatably coupled together about a connecting assembly joint axis. The jaws of the first and second clamps can have respective jaw cavity axes that are parallel to each other. The connecting assembly joint axis and the jaw cavity axes can be parallel to each other. The flexible cable can be flexible steel cable. The first and second clamps can include two clamp halves which can be secured together by a fastener. The elongate insulator can have an elongate insulator rod with a series of sheds secured thereto in spaced apart manner. The antigalloping device can be a first antigalloping device in an antigalloping system on a span of cables. The first antigalloping device can be secured to upper and middle cables at a ⅓ span distance, and the system can further include a second antigalloping device which can be secured to middle and lower cables at a ⅔ span distance, for reducing galloping of the cables.

The present invention can also provide an antigalloping conductor span including upper, middle and lower conductors, each having a span length. A first antigalloping device can be secured to the upper and middle conductors at a ⅓ span distance. A second antigalloping device can be secured to the middle and lower conductors at a ⅔ span distance. The first and second antigalloping devices can each include upper and lower clamps, each having a respective jaw for clamping to respective upper, middle and lower conductors. A connecting assembly can be coupled between the upper and lower clamps. The connecting assembly can include an upper elongate insulator attached to a lower length of flexible cable. The length of flexible cable can be bent and maneuvered during installation. The lower clamp can be rotatably coupled to the connecting assembly at an end of the length of flexible cable. The elongate insulator and the flexible cable are capable of straightening along a longitudinal axis. The lower clamp can be secured to respective middle and lower conductors in an orientation that is transverse to the longitudinal axis. The lower clamp is capable of being rotated between the position transverse to the longitudinal axis and a position inline with the longitudinal axis with opposed tension exerted on the jaws of the upper and lower clamps, for twisting respective middle and lower conductors for reducing galloping of the conductors.

In particular embodiments, the length of flexible cable of the first and second antigalloping devices can be flexibly collapsible under opposed compression. During antigalloping operation, one of the first and second antigalloping devices is capable of being straightened along the longitudinal axis under opposed tension, and substantially at the same time, the length of flexible cable of the other antigalloping device is capable of flexibly collapsing under opposed compression. The upper, middle and lower conductors can be selected conductors in respective upper, middle and lower conductor bundles.

The present invention can also provide a method of reducing galloping in a span of cables including securing an antigalloping device to first and second cables. The antigalloping device can have first and second clamps, each with a respective jaw for clamping to respective first and second cables. A connecting assembly can be coupled between the first and second clamps. The connecting assembly can include an elongate insulator attached to a length of flexible cable. The length of flexible cable can be bent and maneuvered during installation. At least one of the first and second clamps can be rotatably coupled to the connecting assembly. The at least one of the first and second clamps can be oriented in a position transverse to the longitudinal axis. The elongate insulator and the flexible cable can be straightened along a longitudinal axis and the at least one of the first and second clamps rotated between the position transverse to the longitudinal axis and a position inline with the longitudinal axis, under opposed tension exerted on the jaws of the first and second clamps caused by movement of the first and second cables away from each other, for twisting at least one of the first and second cables and reducing galloping.

In particular embodiments, the method can include alternately limiting amount of movement of the first and second cables away from each other when the elongate insulator and the flexible cable are straightened out, and flexibly collapsing the flexible cable under opposed compression caused by movement of the first and second cables towards each other. The first and second clamps can be rotatably coupled to opposite ends of the connecting assembly about respective clamp joint axes. The elongate insulator and the flexible cable can be rotatably coupled together about a connecting assembly joint axis. The jaws of the first and second clamps can be provided with respective jaw cavity axes that are parallel to each other. The clamp joint axes, the connecting assembly joint axis and the jaw cavity axes can be parallel to each other. The flexible cable can be formed from flexible steel cable. The first and second clamps can be provided with two clamp halves which are secured together by a fastener. The elongate insulator can be formed with an elongate insulator rod with a series of sheds secured thereto in spaced apart manner. The antigalloping device can be a first antigalloping device in an antigalloping system on the span of cables. The method further includes securing the first antigalloping device to upper and middle cables at a ⅓ span distance, and securing a second antigalloping device to middle and lower cables at a ⅔ span distance, for reducing galloping of the cables. The upper, middle and lower cables can be positioned in respective upper, middle and lower bundles.

The present invention can also provide a method of reducing galloping in a conductor span having upper, middle and lower conductors. A first antigalloping device can be secured to the upper and middle conductors at a ⅓ span distance. A second antigalloping device can be secured to the middle and lower conductors at a ⅔ span distance. The first and second antigalloping devices can each include upper and lower clamps, each having a respective jaw for clamping to respective upper, middle and lower conductors. A connecting assembly can be coupled between the upper and lower clamps. The connecting assembly can include an upper elongate insulator attached to a lower length of flexible cable. The length of flexible cable can be bent and maneuvered during installation. The lower clamp can be rotatably coupled to the connecting assembly at an end of the length of flexible cable. The lower clamps of the first and second antigalloping devices can be secured to respective middle and lower conductors in an orientation that is transverse to the longitudinal axis. In at least one of the first and second antigalloping devices, the elongate insulator and the flexible cable can be straightened along a longitudinal axis, and the lower clamp rotated, between the position transverse to the longitudinal axis and a position inline with the longitudinal axis with opposed tension exerted on the jaws of the upper and lower clamps caused by movement of associated conductors away from each other, for twisting respective middle and lower conductors for reducing galloping of the conductors.

In particular embodiments, one of the first and second antigalloping devices can be straightened along the longitudinal axis under opposed tension caused by movement of associated conductors away from each other and limiting amount of movement of such conductors away from each other, and substantially at the same time, flexibly collapsing the length of flexible cable of the other antigalloping device under opposed compression caused by movement of associated conductors towards each other. The upper, middle and lower conductors can be positioned in respective upper, middle and lower conductor bundles.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic front view of an antigalloping system or antigalloping span in the present invention.

FIG. 2 is a front view of the an embodiment of an antigalloping device in the present invention.

FIG. 3 is a side view of the antigalloping device of FIG. 2.

FIG. 4 is a side view of the antigalloping device shown in FIG. 3 with the flexible cable straightened out and the lower clamp secured to a conductor in a horizontal orientation.

FIG. 5 is a side view of the antigalloping device shown in FIG. 4 subjected to opposed compressive forces.

FIG. 6 is a side view of the antigalloping device shown in FIG. 4 subjected to opposed tension forces for rotating or twisting the clamped conductor.

FIG. 7 is a side view of the antigalloping device shown in FIG. 6 with the lower clamp rotated in line with the longitudinal axis of the device due to opposed tension forces.

FIG. 8 is a schematic perspective view of a conductor with an aerodynamic ice structure formed thereon, forming a lifting surface.

FIG. 9 is a schematic perspective view of the conductor of FIG. 8 rotated 90° to be in a non aerodynamic lifting orientation.

FIG. 10 is a schematic front view of an antigalloping system or antigalloping span in the present invention illustrating the upper conductor moving up, the middle conductor moving down, and the lower conductor moving up.

FIG. 11 is a schematic front view of an antigalloping system or antigalloping span in the present invention illustrating the upper conductor moving down, the middle conductor moving up, and the lower conductor moving down.

FIG. 12 is a schematic side view of an antigalloping device in the present invention connected to upper and middle bundles of conductors.

FIG. 13 is a schematic side view of an antigalloping device in the present invention connected to middle and lower bundles of conductors.

FIG. 14 is a schematic front view of the device of FIG. 12 connected to the upper and middle bundles.

FIG. 15 is a schematic front view of the device of FIG. 13 connected to the middle and lower bundles.

### DETAILED DESCRIPTION

A description of example embodiments of the invention follows.

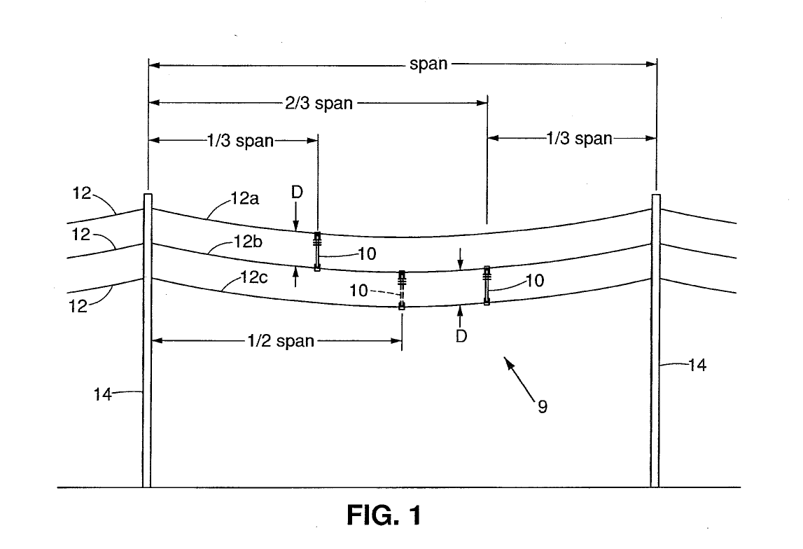

Referring to FIG. 1, a span of electrical transmission phases, lines, cables or conductors 12, between two transmission poles or towers 14, can be for example, about 700 to 1200 feet long and the distance D between phase conductors 12 can be, for example, about 24 to 33 feet. These dimensions can be greater or less, depending upon the situation at hand. For a typical span of around 700 to 1200 feet long, an antigalloping system 9 or antigalloping conductor span in the present invention can include two antigalloping, spacer, or cable twister devices, units or apparatuses 10, for preventing, limiting or reducing galloping of the conductors 12. A first, top or upper antigalloping device 10 can be coupled, connected or secured at the ⅓ span location to and between the first, top or upper phase, line, cable or conductor 12a and the second, intermediate or middle phase, line cable or conductor 12b, and a second, bottom or lower antigalloping device 10 can be coupled, connected or secured at the ⅔ span location to and between the second or middle conductor 12b and the third, bottom or lower phase, line, cable or conductor 12c.

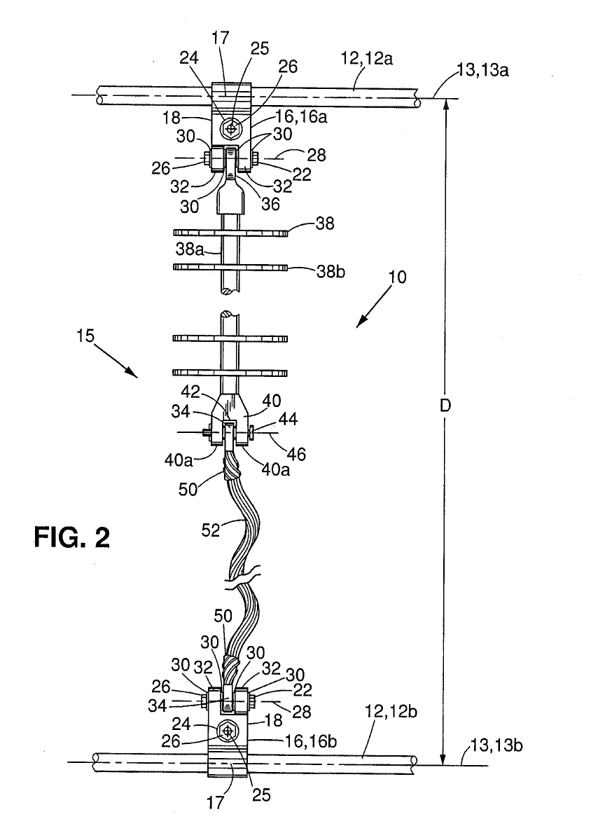

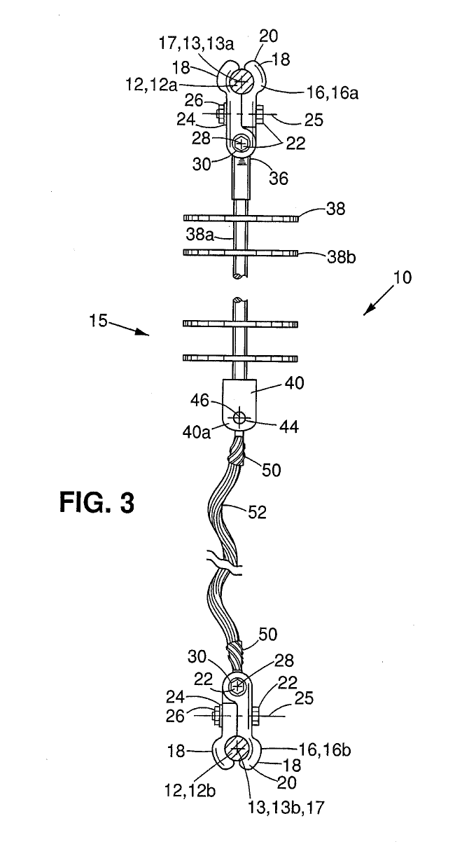

Referring to FIGS. 2 and 3, each antigalloping device 10 can include two clamps 16 with jaws 20 for securement to the conductors 12. The following provides some description for securement in relation to the upper 12a and middle conductors 12b, and it is understood that securement relative to the middle 12b and lower 12c conductors is similar. The first, top or upper clamp 16a can be secured to and clamp the upper conductor 12a in fixed relationship thereto, and the second or lower clamp 16b can be secured to and clamp the middle conductor 12b in fixed relationship thereto. Each clamp 16 can include two opposed clamp halves 18 which can be secured or tightened together by a fastener arrangement, such as bolt 22, washer 24 and nut 26, extending through the clamp halves 18 along a tightening axis 25 that is perpendicular or transverse to the jaw cavity axis 17 of the jaws 20 and the longitudinal axes 13 of conductors 12.

An elongate partially flexible restraining or connecting member or assembly 15 can be coupled or connected between the two clamps 16. The clamps 16 can be pivotably or rotatably coupled or connected to opposite ends of the connecting assembly 15 about clamp joint axes 28, where a tongue or pivot member or fitting 36 or 34 at the opposite ends of the connecting assembly 15 can be rotatably secured in the space or gap between two ears or extensions 32 of the clamp halves 18 of each clamp 16, by a bolt, 22, washers 30 and nut 26 positioned along axes 28. The washers 30 can be positioned between the tongues 34 and 36, ears 32, bolt 22 and nut 26. The washers 30 can be loose, and can damp Aeolian vibration. The axes 28 can be parallel to the longitudinal axes 13 of the conductors 12, such as axis 13a of conductor 12a and axis 13b of conductor 12b.

The connecting assembly 15 can be electrically insulative and can include an elongate rigid electrical insulator 38 being at an upper portion, attached to a length of flexible cable 52, such as steel cable, being at a lower portion, which can be generally nonstretchable once straightened out. The insulator 38 can include a rigid elongate insulator rod 38a extending along a longitudinal axis X, and a series of sheds 38b spaced apart thereon. Tongue 36 can be at one end of rod 38a, such as an upper end, and a clevis joint member or fitting 40 can be at the other or opposite end, such as a lower end. The tongue 36 can be pivotably or rotatably coupled or connected to upper clamp 16a about axis 28 as described above. The cable 52 can be galvanized steel aircraft cable, and often can be 3/16 to ⅜ inches in diameter. The cable 52 can be rotatably coupled or connected to the insulator 38 at the clevis fitting 40. The cable 52 can be secured to a pivot member 34, such as a spool, by a helical grip 50 at each opposite end of the cable. One pivot member 34 secured to a first or upper end of cable 52 can be pivotably or rotatably coupled or connected to the clevis fitting 40 in the space or gap between two ears or extensions 40a, by a pin or rod 44 along a connecting assembly clevis joint axis 46. Axis 46 can be parallel to axes 28, axis 17, and the axes 13 of the conductors 12, axes 13a and 13b. Washers 30 can be positioned between these mating components. The other pivot member 34 secured at the opposite, second or lower end of cable 52 can be pivotably or rotatably coupled or connected to lower clamp 16b about axis 28 as described above.

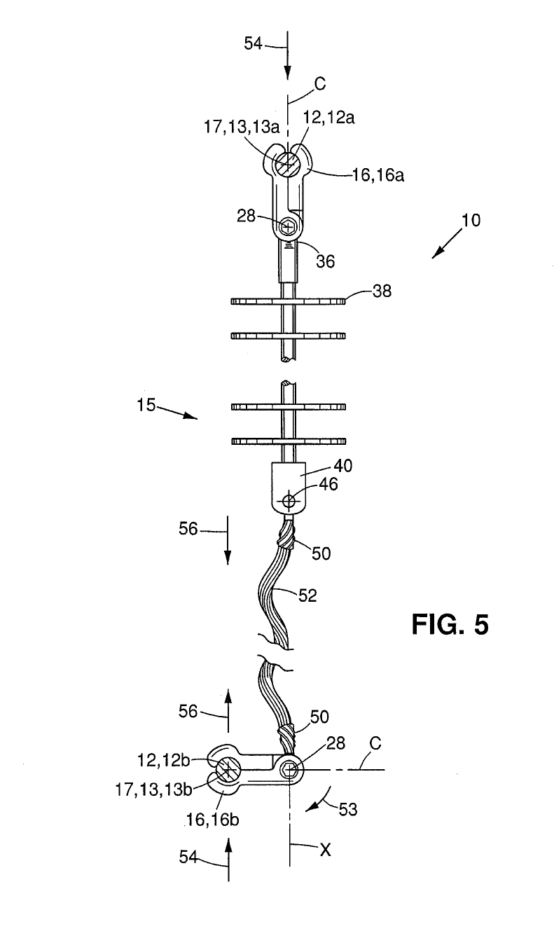

As seen in FIGS. 2 and 3, typically the antigalloping device 10 is positioned so that the insulator 38 is above the cable 52, and the cable 52 hangs downwardly. The flexible cable 52 is flexibly bendable which allows the cable 52 to be bent or coiled in a compact manner such as for storage, and then uncoiled, bent and maneuvered from a hanging orientation or configuration into position for easy installation. In order to allow such bending and maneuvering, other than possible coatings or protective jacketing on the cable 52, there are no supporting, stiffening or reinforcing members, springs, tubes or rods, added to the cable 52 to substantially stiffen or support the cable 52, to keep it straight or make it rigid. As a result, the cable 52 is flexibly collapsible when bent, or when opposed compression forces in the direction of arrows 54 (FIG. 5) are exerted on or from the jaws 20 of clamps 16 to the connecting assembly 15, caused by conductors 12 moving towards each other in the direction of arrows 54. The insulator 38 can be one that is commercially available, and can be in some embodiments, about 12 feet long, so that for distances D between conductors 12 ranging from about 24 to 33 feet, the length of flexible cable 52 can be about 12 to 21 feet long. The length of cable 52 can be varied to adjust to different distances between the conductors 12.

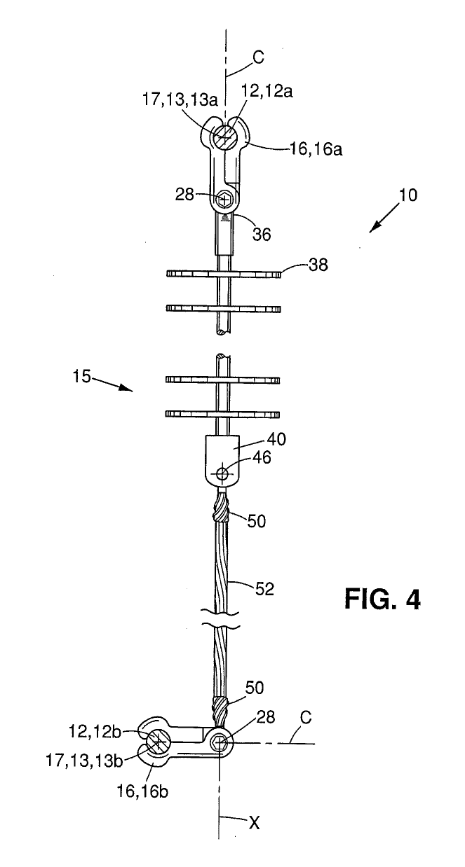

Referring to FIGS. 1 and 4, when installing the antigalloping devices 10 in a typical conductor span between about 700 to 1200 feet, the first device 10 can be first secured to upper conductor 12a at the ⅓ span distance by securing or clamping the upper or top clamp 16a to the upper conductor 12a by tightening bolt 22 along axis 25, so that clamp 16a and its longitudinal axis C is fixed in a substantially vertically downwardly hanging orientation generally or substantially inline with the longitudinal axis X of the insulator 38 and the hanging straightened connecting assembly 15, that extends or hangs downwardly from clamp 16a. The upper clamp 16a can be installed in place by a worker on a helicopter, or alternately from a trolley. The flexible cable 52 hanging below the insulator 38 of the connecting assembly 15 can be bent and maneuvered easily into position and the lower or bottom clamp 16b connected to the lower end of cable 52 can be secured or clamped to the middle conductor 12b by tightening bolt 22 along axis 25, so that clamp 16b and its longitudinal axis C is fixed in a horizontal orientation that is transverse, perpendicular, 90° or at a right angle to vertical or the longitudinal axis X. The flexible cable 52 can flexibly bend to allow lower clamp 16b to be easily rotated into the desired horizontal orientation and then can be pulled to be straight and aligned with insulator 38 along longitudinal axis X if desired. The lower clamp 16b can be installed by a worker on a trolley.

The second device 10 can be secured at the ⅔ span distance, in a similar manner, but in which the upper clamp 16a is fixed or secured to the middle conductor 12b in a substantially vertically downwardly hanging orientation generally or substantially inline with the longitudinal axis X of the insulator 38 and the connecting assembly 15, and the lower clamp 16b can be secured to the lower conductor 12c in a horizontal orientation transverse, perpendicular, 90° or at a right angle to vertical or the longitudinal axis X. The clamps 16a and 16b of the second antigalloping device 10 can be installed by a worker on a trolley. Depending upon the relative positions of the conductors 12, the longitudinal axis X of the connecting assemblies 15 and the axis C of the upper clamp 16a can be positioned inline with vertical, or at an angle relative to vertical. If desired, in some embodiments, the axis C of the lower clamps 16b can be oriented transverse to the longitudinal axis X in a manner that is not horizontal, but at an angle relative to horizontal. By using a long flexible cable 52 to form a large or substantial part of the connecting assembly 15, the antigalloping devices 10 in the present invention can cost about half the price of existing devices and also can be installed more easily, quickly and with less cost than devices in the prior art.

Referring to FIG. 5, since the flexible cable 52 is not rigidly supported, reinforced or stiffened by additional members, if conductors 12, such as 12a and 12b, move towards each other in the direction of arrows 54, such as due to wind, during galloping, an opposed compressive force is exerted on antigalloping device 10, via the jaws 20 of clamps 16a and 16b, and can cause the ends of cable 52 to move towards each other in the direction of arrows 56, thereby collapsing, bending or buckling cable 52 to compensate for the movement of cables 12a and 12b towards each other. In addition, pivoting of insulator 38 and cable 52 about axes 28 and 46 can also occur. The antigalloping operation of device 10 does not occur during such movement of conductors 12a and 12b towards each other. The flexible nature of cable 52 attached to the middle conductor 12b or lower conductor 12c may provide some damping, however, this effect is typically minor and secondary to the normal antigalloping operation of system 9 and devices 10 as described below.

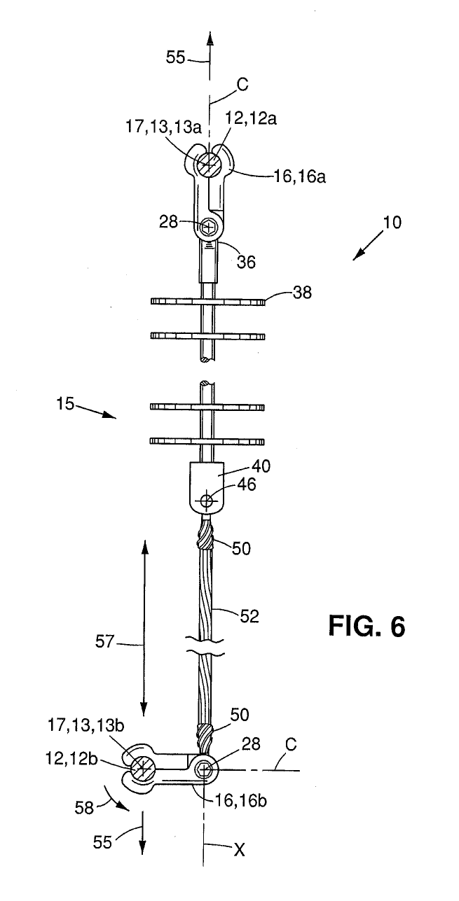

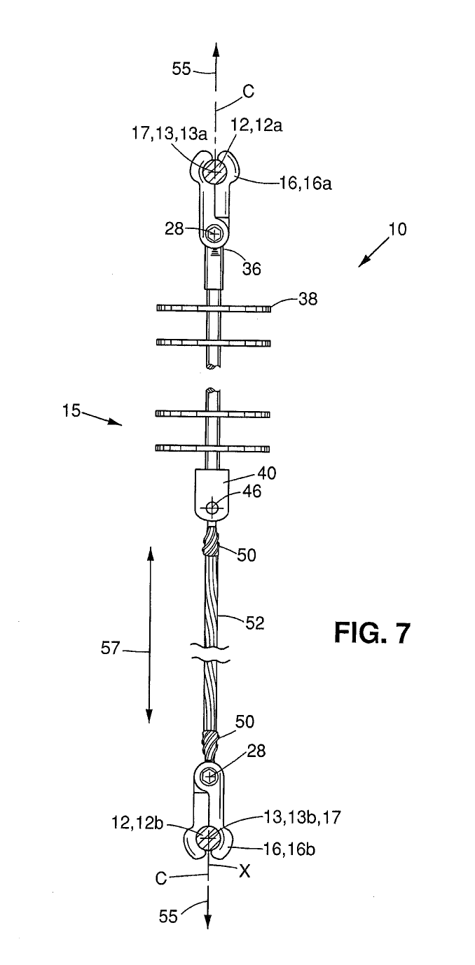

Referring to FIGS. 6 and 7, when conductors 12, such as 12a and 12b, move away from each other in the direction of arrows 55, such as due to wind, during large amplitude galloping, an opposed tension force in the direction of arrows 55 is exerted on antigalloping device 10, via the jaws 20 of clamps 16a and 16b. This can straighten out or stretch insulator 38 and cable 52 along longitudinal axis X, and exert an opposed tension force on cable 52, as indicated by arrows 57. Once cable 52 is pulled tight and straightened out along longitudinal axis X, the cable 52 does not stretch any further. When cable 52 is straightened out, large amplitude galloping motion of conductors 12a and 12b away from each other in the direction of arrows 55 can be restrained. With upper clamp 16a clamped to upper conductor 12a with its longitudinal axis C inline with the longitudinal axis X of antigalloping device 10, upper clamp 16a usually does not exert any significant twisting on upper conductor 12a. Further movement of the upper 12a and middle conductors 12b away from each other causes device 10 to pull and rotate the lower clamp 16a about axis 28, and with it the clamped middle cable 12b, downwardly in the direction of arrow 58. If the movement of conductors 12a and 12b away from each other is large enough, the lower clamp 16b and the attached middle cable 12b can be pulled or rotated 90° until the longitudinal axis C of lower clamp 16b is inline with the longitudinal axis X of device 10, as seen in FIG. 7, where antigalloping device 10 is extended into a fully straightened elongate position.

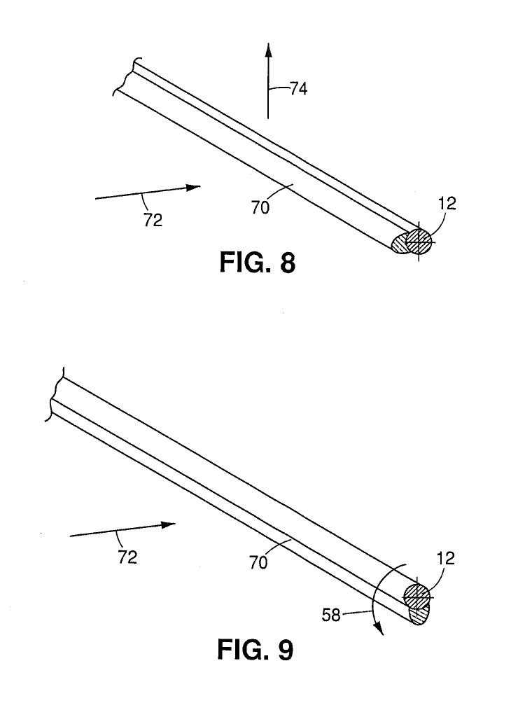

When ice forms an aerodynamic lifting structure 70 (FIG. 8) on a conductor 12, horizontal wind 72 blowing across structure 70 causes upward lift of the conductor 12 in the direction of arrow 74. Twisting the conductor 12 (FIG. 9) in the direction of arrow 58 can make the span of the conductor 12 stable by changing the position or angle of the aerodynamic lifting structure 70 up to 90° downward, so that the structure 70 is not in an aerodynamic wind lifting position or orientation relative to the direction of the wind 72, thereby preventing or reducing lift and galloping of the conductor 12. As little as a 10° and 15° change in angle can reduce enough lift to make the span of the conductor 12 stable. The amount of rotation of conductor 12b caused by lower clamp 16b can vary between 0° and 90°, or intermediate angles therebetween, depending upon the amount of distance that conductors 12a and 12b move apart from each other and the position or angle that the lower clamp 16b is initially oriented. As previously mentioned, operation of antigalloping device 10 between the middle 12b and lower 12c conductors is similar. Consequently, large amplitude galloping movement of the conductors 12 away from each other can be restrained by the length of the antigalloping devices 10 secured and extended therebetween, and aerodynamic lifting of the middle 12b and lower conductors 12c can be reduced or prevented by twisting or conductors 12b and 12c.

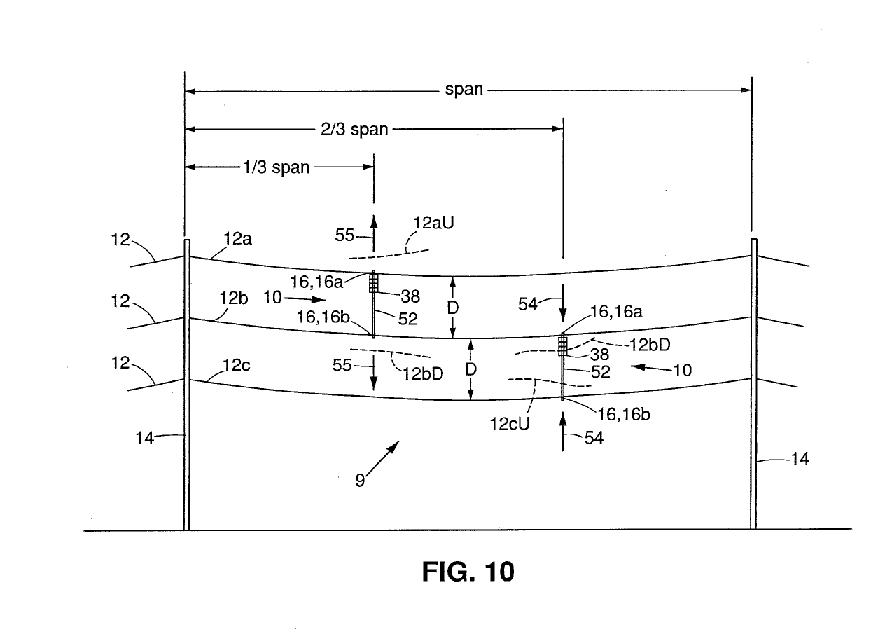

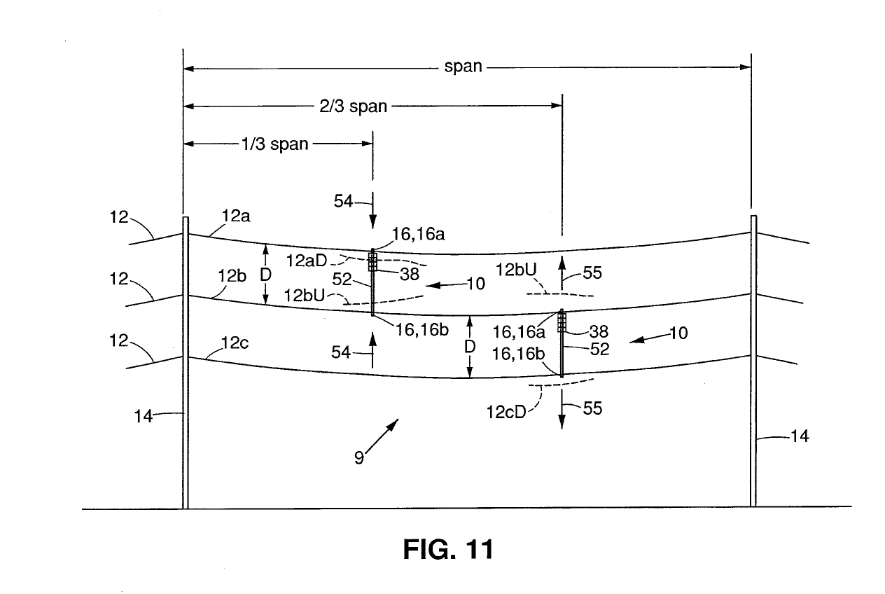

Referring to FIGS. 10 and 11, the antigalloping system 9 or antigalloping conductor span in some embodiments, can reduce or prevent the two typical modes of gallop in a conductor span. The first mode is symmetrical about the mid-span, in the shape of a ½ sine wave, with maximum displacement at the mid-span. The second mode is anti-symmetrical about the mid-span in the shape of a full sine wave with maximum displacement at the two ¼ span points. The first and second modes have equal displacement at the ⅓ span and ⅔ span points, which is about 86% of the maximum displacement.

In one example, conductors 12 can have a diameter of about 1,162 inches, a weight of about 1.159 lb/ft, a breaking strength of about 31,900 lbs., a torsional stiffness of about 9071 lb.ft²/Rad, a first natural frequency of 0.3 Hz and a second natural frequency of 0.6 Hz. The length of the span can be 700 ft, with the ⅓ span length or distance being about 233 ft., and the ⅔ span length or distance being about 466 ft., a conductor 12 tension of about 3240 lb., a torque stiffness at the mid-span of about 5.2 ft.lb/Rad, a double amplitude motion of about 5.2 ft, a moment arm of the lower clamps 16b of about 3.5 inches, a maximum axial tension force in direction of arrows 55 of about 50 lb., and a torque stiffness at the ⅓ span and ⅔ span locations of about 5.7 ft lb./Rad. The maximum axial tension force of 50 lb. in the direction of arrows 55 can exert a torque of about 15 ft.lb., which exceeds the torque required to rotate the conductors 12 nearly 90°.

Referring back to FIG. 10 when all three phase conductors 12a, 12b, and 12c are galloping in the first mode, at a particular moment when the upper conductor or phase 12a is at its maximum upward motion or position 12aU, the middle conductor or phase 12b can be at its maximum downward motion or position 12bD, and the lower conductor or phase 12c can be at its maximum upward motion or position 12cU. In the embodiment having the dimensions or properties of the above example, the maximum up-down double amplitude motion can be about 6 ft, where the up-down double amplitude motion at the ⅓ space and ⅔ span locations can be about 5.2 feet. As a result, the anti-galloping device 10 secured to the upper 12a and middle conductors 12b at the ⅓ span location, is subjected to opposite tension forces in the direction of arrows 55 due to the movement of conductors 12a and 12b in opposite directions shown by arrows 55, straightening insulator 38 and cable 52 along longitudinal axes X and rotating lower clamp 16b about axis 28 to twist or rotate middle conductor 12b, thereby reducing large amplitude motion of conductors 12a and 12b, and reducing or preventing lifting and galloping of middle conductor 12b. Although upper conductor 12a is not twisted by antigalloping device 10, with device 10 being in tension, large amplitude motion of upper conductor 12a and middle conductor 12b away from each other in the direction of arrows 55 can be restrained by the straightened device 10 between the upper conductor 12a and the middle conductor 12b to reduce or prevent galloping of the upper conductor 12a as well as middle conductor 12b. The antigalloping device 10 secured to the middle 12b and lower 12c conductors at the ⅔ span location is subjected to opposed compression forces in the direction of arrows 54 due to the movement of conductors 12b and 12c towards each other in the direction of arrows 54, and is under a slack or collapsed no load condition, and therefore, generally does not restrict motion of or twist a conductor 12b or 12c.

Referring to FIG. 11, after ½ cycle of the gallop motion, the upper conductor 12a is at its maximum downward motion or position 12aD, the middle conductor 12b is at its maximum upward motion or position 12bU, and the lower conductor 12c is at its maximum downward motion or position 12cD. The antigalloping device 10 at the ⅓ span location is now subjected to opposed compression forces in the direction of arrows 54 due to the movement of conductors 12a and 12b towards each other in the direction of arrows 54, and therefore, generally does not restrict motion of or twist a conductor 12a or 12b. In addition, the antigalloping device 10 at the ⅔ span location is now subjected to opposed tension forces in the direction of arrows 55 due to the movement of conductors 12b and 12c away from each other in the direction of arrows 55, thereby straightening insulator 38 and cable 52 along longitudinal axis X and rotating lower clamp 16b about axis 28 to twist or rotate lower conductor 12c, thereby reducing large amplitude motion of conductors 12b and 12c, and reducing or preventing lifting and galloping of lower conductor 12c. The large amplitude galloping motion of the middle 12b and lower 12c conductors away from each other in the direction of arrows 55 can be restrained by the straightened device 10 secured between the middle conductor 12b and the lower conductor 12c. The second gallop mode can be twice as fast as the first mode, while the maximum amplitudes at the ⅓ span and ⅔ span locations can be the same. Consequently, during galloping, one antigalloping device 10 can be under tension and stabilizing the entire span for ½ the cycle of the gallop motion while the other antigalloping device 10 is under no load or provides no support, and then in the other ½ of the cycle of the gallop motion, the antigalloping device 10 that was previously under tension is now under no load and the other antigalloping device 10 that was previously unloaded is now under tension and stabilizing the entire span. As a result, the two antigalloping devices 10 can individually sequentially stabilize galloping in the span, each for ½ the cycle of the gallop motion. Each antigalloping device 10 does not reduce or prevent galloping when opposed compression forces are exerted thereon, but sufficient reduction or prevention of galloping can be obtained only when the antigalloping devices 10 are subjected to opposed tension, by restricting movement of the attached cables or conductors 12 apart from each other, and reducing or preventing lift of the conductor attached to the lower clamp 16b. This can create a square wave of the force waveform, and these square wave time histories or highly non-linear motion time histories can be easily analyzed by fourier series methods by breaking the wave form down into harmonic components.

The conductors 12 can act as linear springs to create the opposed tension in the antigalloping devices 10. Although the antigalloping system 9 or antigalloping span is shown in the drawings to have a device 10 at the ⅓ span on the left between the upper 12a and middle 12b conductors, and a device 10 at the ⅔ span at the right between the middle 12b and lower 12c conductors, in other embodiments, the positions can be reversed. Also, the span could be measured from the right-hand side with the ⅓ span being at the right and the ⅔ span being at the left, or the span could be viewed while facing the opposite side of the span.

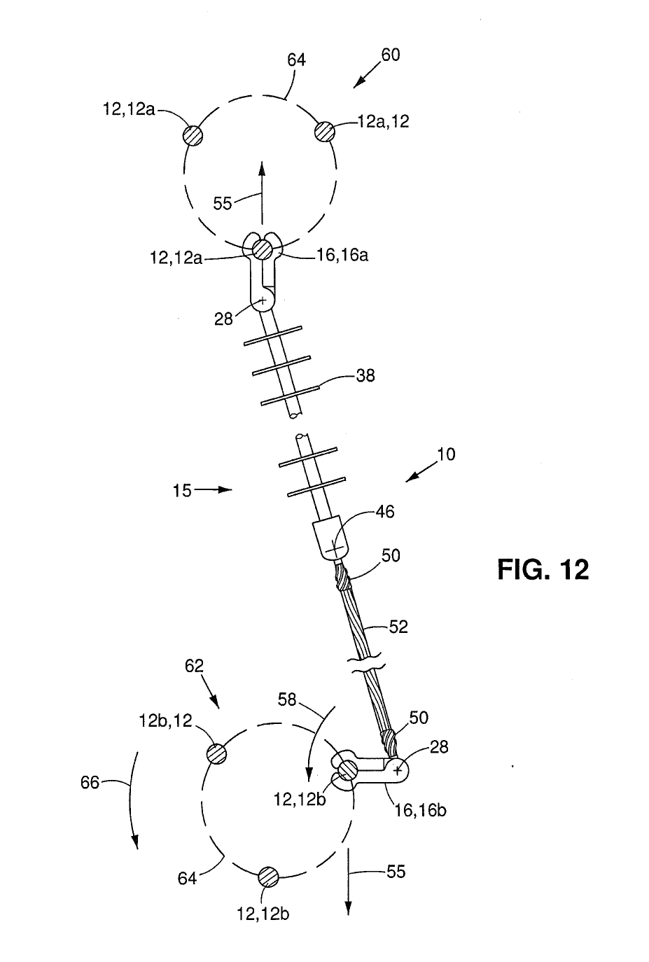

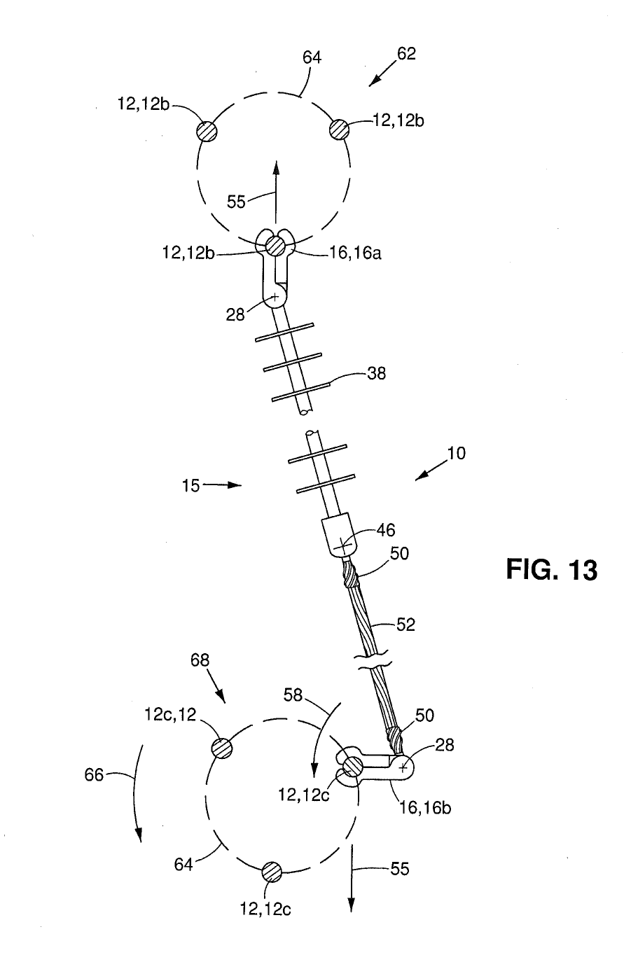

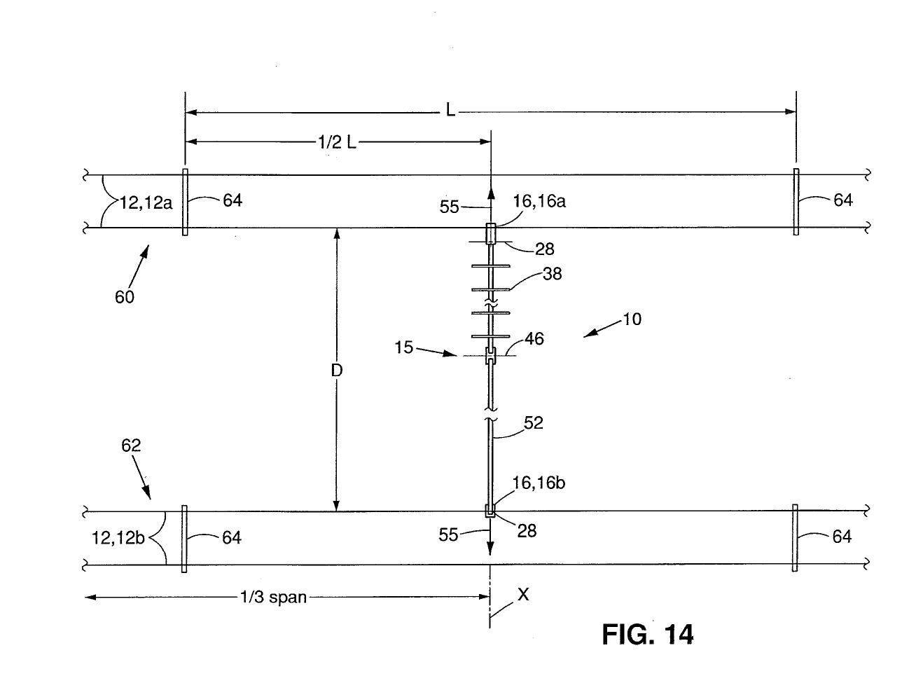

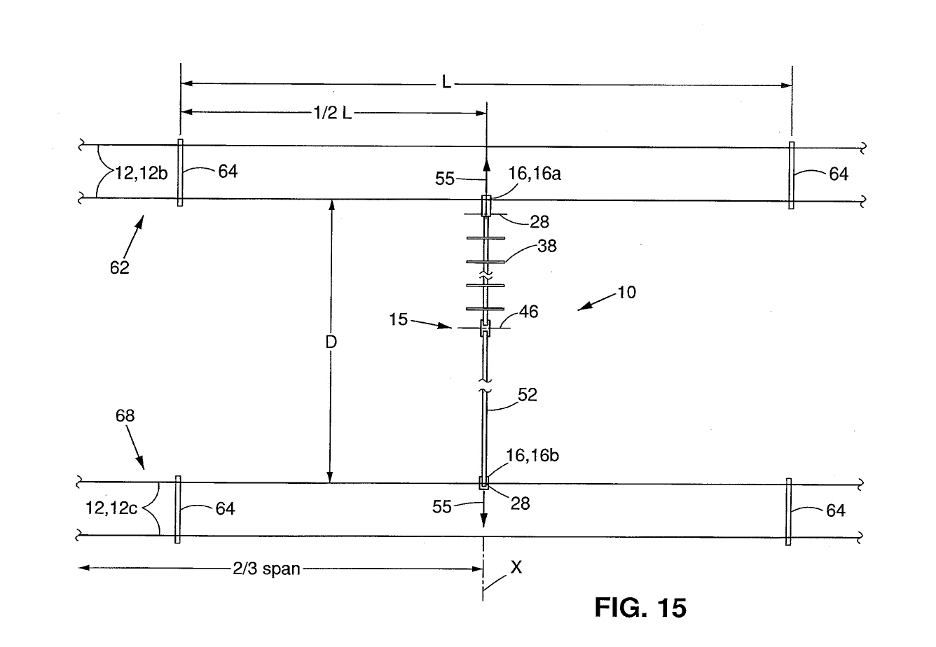

Referring to FIGS. 12-15, in other embodiments, the anti-galloping system 9 or anti-galloping span can include bundles of conductors 12, where each phase can have a bundle. FIGS. 12 and 14 depict a first, top or upper triple bundle 60 containing 3 first, top or upper phases, lines, cables or conductors 12a, and a second, intermediate or middle triple bundle 62 containing 3 second, intermediate or middle phases, lines, cables or conductors 12b. The middle bundle 62 and the third, bottom or lower triple bundle 68 of 3 third, bottom or lower phases, lines, cables or conductors 12c is shown in FIGS. 13 and 15. It is understood that bundles of 2 conductors or bundles of more than 3 conductors are also envisioned. Each bundle 60, 62, and 68, can include bundle spacers, rings, members or devices 64 for spacing the conductors 12 in each bundle. Each spacer 64 can be spaced apart from each other by a length or distance L, for example in some embodiments, about 200 ft. The antigalloping devices 10 can be secured to the ⅓ span and ⅔ span locations in a span of conductors 12, to upper 12a, middle 12b, and lower 12c conductors, in the upper 60, middle 62, and lower 68 bundles. Depending upon the relative positions of the conductors 12 and bundles 60, 62 and 68, the longitudinal axes X of the connecting assemblies 15 and axes C of the upper clamps 16a can be inline or at an angle to vertical.

Referring to FIGS. 12 and 14, the upper clamp 16a of the antigalloping device 10 at the ⅓ span location can be secured to an upper conductor 12a in the upper bundle 60 that is at the bottom of the upper bundle 60. The lower clamp 16b can be secured to a middle conductor 12b in the middle bundle 62 that is near the top of the middle bundle 62. The device 10 can be positioned halfway between two spacers 64, at the ½ L location, for example, 100 ft when L=200 ft. Consequently, when the antigalloping device 10 at the ⅓ span location is subjected to opposed tension forces by movement of conductors 12a and 12b within bundles 60 and 62 away from each other in the direction of arrows 55, and straightened out along longitudinal axis X, large amplitude galloping motion in the upper conductors 12a of upper bundle 60 and the middle conductors 12b of the middle bundle 62 away from each other in the direction of arrows 55 can be restrained by the length of the antigalloping device 10 secured to and extending therebetween, and the lower clamp 16b and with it the clamped middle conductor 12b, can rotate or twist about axis 28 in the direction of arrow 58 to prevent or reduce aerodynamic lift in a similar manner as previously described. Since the middle conductors 12b in the middle bundle 62 are secured to each other by the spacers 64, the middle bundle 62 can in some cases also rotate in the direction of arrow 66. In this manner, aerodynamic lift of the middle conductors 12b in the middle bundle 62 can be reduced or prevented.

Referring to FIGS. 13 and 15, the upper clamp 16a of the antigalloping device 10 at the ⅔ span location can be secured to a middle conductor 12b in the middle bundle 62 that is at the bottom of the middle bundle 62. The lower clamp 16b can be secured to a lower conductor 12c in the lower bundle 68 that is near the top of the lower bundle 68. The device 10 can be positioned halfway between two spacers 64, at the ½ L location. When the antigalloping device 10 at the ⅔ span location is subjected to opposed tension forces by movement of conductors 12b and 12c in the direction of arrows 55 and straightened out along longitudinal axis X, large amplitude galloping motion in the middle conductors 12b of the middle bundle 62 and the lower conductors 12c of the lower bundle 68 away from each other in the direction of arrows 55 can be restrained by the length of the antigalloping device 10 secured to and extending therebetween, and the lower clamp 16b and with it the clamped lower conductor 12c, can rotate or twist about axis 28 in the direction of arrow 58 to prevent or reduce aerodynamic lift in a similar manner as previously described. Since the lower conductors, 12c in the lower bundle 68 are secured to each other by the spacers 64, the lower bundle 68 in some cases can also rotate in the direction of arrow 66. In this manner, aerodynamic lift of the lower conductors 12c in the lower bundle 68 can be reduced or prevented. Galloping over the span can be reduced or prevented by sequential operation of the two antigalloping devices 10 in a similar manner as previously described earlier with respect to FIGS. 10 and 11. In some embodiments, different conductors 12 or conductor series in the bundles 60, 62 and 68 can be clamped or connected to than those shown.

In some embodiments, the antigalloping system 9 or antigalloping conductor span (single or bundled conductors) can have a span of conductors 12 that is less than 700 feet long, for example, 500 to 600 feet. In such a case, a single antigalloping device 10 can be positioned at the ½ span location (shown in FIG. 1 in phantom) between the middle 12b and lower 12c conductors (or middle and lower bundles 62 and 68), which can sufficiently reduce gallop. If the span is longer than 1200 feet, for example 1800 feet, three antigalloping devices 10 can be used, at the ⅓ span location between the upper and middle conductors 12a and 12b (or upper and middle bundles 60 and 62), and at the ½ and ⅔ span locations between the middle and lower conductors 12b and 12c (or middle and lower bundles 62 and 68), for example, as seen in FIG. 1.

While this invention has been particularly shown and described with references to example embodiments thereof, it will be understood by those skilled in the art that various changes in form and details may be made therein without departing from the scope of the invention encompassed by the appended claims.

For example, although various dimensions have been provided, it is apparent that dimensions and sizes can vary, depending upon the situation at hand. In some embodiments, the upper clamp 16a can be also positioned in a horizontal orientation for twisting conductors at both ends of device 10. Flexible cable 52 can be replaced with flexible rope, synthetic or natural materials, or chain. Although a particular clamp 16 has been shown, other suitable clamps can be used. The connecting assembly 15 can be positioned with the insulator 38 at the bottom and the flexible cable 52 at the top. In some cases, pivots at axes 28 and/or 46 can be omitted, and the flexibility of cable 52 being used to provide the ability for lower clamp 16b to rotate. In some embodiments, the insulator 38 can have flexibility. If a span contains more than three spaced conductors or bundles, additional antigalloping devices can be secured. Although the present invention has been shown for electrical transmission spans, in other embodiments, the present invention can be used for preventing or reducing galloping in cables in other fields, such as cables supporting structures, including towers. In addition, directional terms, including terms such as upper, lower, top, bottom, horizontal or vertical have been used to describe the antigalloping devices, systems or spans when oriented in place on a certain span of cables or conductors, and it is understood that the antigalloping devices and cables can be positioned in other orientations. Also, it is understood that dimensions can vary, depending upon the situation at hand.

What is claimed is:

1. An antigalloping device comprising:
first and second clamps each having a respective jaw for clamping to respective first and second cables; and
a connecting assembly coupled between the first and second clamps, the connecting assembly comprising an elongate insulator attached to a length of flexible cable, the length of flexible cable capable of being bent and maneuvered during installation, at least one of the first and second clamps being rotatably coupled to the connecting assembly, the elongate insulator and the flexible cable capable of straightening along a longitudinal axis, and the at least one of the first and second clamps being orientatable in a position transverse to the longitudinal axis for being rotatable between the position transverse to the longitudinal axis and a position inline with the longitudinal axis, under opposed tension exerted on the jaws of the first and second clamps, for twisting at least one of the first and second cables for reducing galloping.

2. The device of claim 1 in which the length of flexible cable is flexibly collapsible under opposed compression.

3. The device of claim 1 in which the first and second clamps are rotatably coupled to opposite ends of the connecting assembly about respective clamp joint axes.

4. The device of claim 3 in which the elongate insulator and the flexible cable are rotatably coupled together about a connecting assembly joint axis.

5. The device of claim 4 in which the jaws of the first and second clamps have respective jaw cavity axes that are parallel to each other.

6. The device of claim 5 in which the clamp joint axes, the connecting assembly joint axis and the jaw cavity axes are parallel to each other.

7. The device of claim 1 in which the flexible cable comprises flexible steel cable.

8. The device of claim 1 in which the first and second clamps comprise two clamp halves which are secured together by a fastener.

9. The device of claim 1 in which the elongate insulator comprises an elongate insulator rod with a series of sheds secured thereto in spaced apart manner.

10. The device of claim 1 in which the antigalloping device is a first antigalloping device in an antigalloping system on a span of cables, the first antigalloping device for being secured to upper and middle cables at a ⅓ span distance, and the system further comprising a second antigalloping device for being secured to middle and lower cables at a ⅔ span distance, for reducing galloping of the cables.

11. An antigalloping conductor span comprising:
upper, middle and lower conductors each having a span length;
a first antigalloping device secured to the upper and middle conductors at a ⅓ span distance; and
a second antigalloping device secured to the middle and lower conductors at a ⅔ span distance, the first and second antigalloping devices each comprising:
upper and lower clamps, each having a respective jaw for clamping to respective upper, middle and lower conductors, and
a connecting assembly coupled between the upper and lower clamps, the connecting assembly comprising an upper elongate insulator attached to a lower length of flexible cable, the length of flexible cable capable of being bent and maneuvered during installation, the lower clamp being rotatably coupled to the connecting assembly at an end of the length of flexible cable, the elongate insulator and the flexible cable capable of straightening along a longitudinal axis, and the lower clamp being secured to respective middle and lower conductors in an orientation that is transverse to the longitudinal axis, the lower clamp capable of being rotated between the position transverse to the longitudinal axis and a position inline with the longitudinal axis with opposed tension exerted on the jaws of the upper and lower clamps, for twisting respective middle and lower conductors for reducing galloping of the conductors.

12. The antigalloping conductor span of claim 11 in which the length of flexible cable of the first and second antigalloping devices is flexibly collapsible under opposed compression.

13. The antigalloping conductor span of claim 12 in which during antigalloping operation, one of the first and second antigalloping devices is capable of being straightened along the longitudinal axis under opposed tension, and substantially at the same time, the length of flexible cable of the other antigalloping device is capable of flexibly collapsing under opposed compression.

14. The antigalloping conductor span of claim 11 in which the upper, middle and lower conductors are selected conductors in respective upper, middle and lower conductor bundles.

15. A method of reducing galloping in a span of cables comprising:
securing an antigalloping device to first and second cables, the antigalloping device having first and second clamps each with a respective jaw for clamping to respective first and second cables, a connecting assembly being coupled between the first and second clamps, the connecting assembly comprising an elongate insulator attached to a length of flexible cable, the length of flexible cable capable of being bent and maneuvered during installation, at least one of the first and second clamps being rotatably coupled to the connecting assembly;
orientating the at least one of the first and second clamps in a position transverse to the longitudinal axis: and
straightening the elongate insulator and the flexible cable along a longitudinal axis and rotating the at least one of the first and second clamps between the position transverse to the longitudinal axis and a position inline with the longitudinal axis, under opposed tension exerted on the jaws of the first and second clamps caused by movement of the first and second cables away from each other, for twisting at least one of the first and second cables and reducing galloping.

16. The method of claim 15 further comprising alternately limiting amount of movement of the first and second cables away from each other when the elongate insulator and the flexible cable are straightened out, and flexibly collapsing the flexible cable under opposed compression caused by movement of the first and second cables towards each other.

17. The method of claim 15 further comprising rotatably coupling the first and second clamps to opposite ends of the connecting assembly about respective clamp joint axes.

18. The method of claim 17 further comprising rotatably coupling the elongate insulator and the flexible cable together about a connecting assembly joint axis.

19. The method of claim 18 further comprising providing the jaws of the first and second clamps with respective jaw cavity axes that are parallel to each other.

20. The method of claim 19 further comprising positioning the clamp joint axes, the connecting assembly joint axis and the jaw cavity axes parallel to each other.

21. The method of claim 15 further comprising forming the flexible cable from flexible steel cable.

22. The method of claim 15 further comprising providing the first and second clamps with two clamp halves which are secured together by a fastener.

23. The method of claim 15 further comprising forming the elongate insulator with an elongate insulator rod with a series of sheds secured thereto in spaced apart manner.

24. The method of claim 15 in which the antigalloping device is a first antigalloping device in an antigalloping system on the span of cables, the method further comprising:
securing the first antigalloping device to upper and middle cables at a ⅓ span distance; and
securing a second antigalloping device to middle and lower cables at a ⅔ span distance, for reducing galloping of the cables.

25. The method of claim 24 further comprising positioning the upper, middle and lower cables in respective upper, middle and lower cable bundles.

26. A method of reducing galloping in a conductor span having upper, middle and lower conductors, comprising:
securing a first antigalloping device to the upper and middle conductors at a ⅓ span distance;
securing a second antigalloping device to the middle and lower conductors at a ⅔ span distance, the first and second antigalloping devices each comprising:
upper and lower clamps, each having a respective jaw for clamping to respective upper, middle and lower conductors; and
a connecting assembly coupled between the upper and lower clamps, the connecting assembly comprising an upper elongate insulator attached to a lower length of flexible cable, the length of flexible cable capable of being bent and maneuvered during installation, the lower clamp being rotatably coupled to the connecting assembly at an end of the length of flexible cable;
securing the lower clamps of the first and second antigalloping devices to respective middle and lower conductors in an orientation that is transverse to the longitudinal axis; and
straightening the elongate insulator and the flexible cable along a longitudinal axis, and rotating the lower clamp, of at least one of the first and second antigalloping devices between the position transverse to the longitudinal axis and a position inline with the longitudinal axis with opposed tension exerted on the jaws of the upper and lower clamps caused by movement of associated conductors away from each other, for twisting respective middle and lower conductors for reducing galloping of the conductors.

27. The method of claim 25 further comprising:
straightening one of the first and second antigalloping devices along the longitudinal axis under opposed tension caused by movement of associated conductors away from each other and limiting amount of movement of such conductors away from each other; and
substantially at the same time flexibly collapsing the length of flexible cable of the other antigalloping device under opposed compression caused by movement of associated conductors towards each other.

28. The method of claim 26 further comprising positioning the upper, middle and lower conductors in respective upper, middle and lower conductor bundles.
